(19) United States
(12) Patent Application Publication
(10) Pub. No.: US 2008/0040176 A1
(43) Pub. Date: Feb. 14, 2008

(54) Online Protection Plan Supplemental Services

(75) Inventor: Kenneth D. Ehling, Fridley, MN (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: MONTAGE, INC., Roseville, MN (US)

(21) Appl. No.: 11/461,117

(22) Filed: Jul. 31, 2006

(51) Int. Cl. G05B 19/418

(52) U.S. Cl. 705/8

(57) ABSTRACT

A system or method for providing online services to supplement furniture protection plans. Services provided by the system may include e-mail reminders, technician referrals, promotional giveaways, and home-care related tips and products. Customers access these services on a website using a using a unique code that may be available on their furniture protection plan. This allows the website to be dynamically tailored to the furniture retailer where the protection plan was purchased. Use of these online supplemental services also facilitates pre-service contact between a protection plan provider and customer.

### BACKGROUND OF THE INVENTION

Protection plans are commonplace in the furniture and home-care related industries. Many consumers seek to protect their purchases with a no-hassle repair, warranty, service contracts, or replacement policy, commonly referred to as a protection plan. Often, furniture retailers are unable or unwilling to offer such plans themselves for a variety of reasons. However, in order to compete in the marketplace or for other reasons, many furniture retailers choose to offer protection plans through a third party protection plan provider. Typically, the retailer purchases protection plans from the provider in bulk and sells them to consumers at the point of sale. From that point forward, the consumer typically deals directly with the plan provider if any problems arise with their purchase. This allows the furniture retailer to provide a service desired by their customer without the associated logistical burden.

A variety of furniture and home-care related protection plans are available to fit the furniture retailer's individual needs. Examples include individual fabric, leather, or mattress plans or combination plans for multiple item purchases of fabric, leather, vinyl upholstery, area rugs, mattresses, case goods, or other hard surface furniture. The protection plan documents lay out the details and provide a telephone number or website for the customer to direct any service requests or inquiries.

Although a vast majority of customers' problems are serviced by the protection plan provider, many protection plan providers are searching for ways to minimize the need for technician services and replacements. There are two main ways to minimize the number of services. First, the customer's problem may be prevented if customers follow the proper procedures to care for their furniture as outlined in the documentation provided at the time of sale. Unfortunately, many customers read the materials once and forget or never read the materials at all. The main problem with prevention is that plan providers often do not have the contact information of the customer who purchased a protection plan until the customer calls with a problem. Once the customer is calling with a problem, it is likely too late to prevent a request for service from being filed. The second way of minimizing the number of services is by denying services when the problem is outside the scope of the plan. Some denials are inevitable because not all problems fall within the scope of plan; however it is preferable to avoid denials because they often results in unhappy customers.

Customers often associate their experiences with their protection plan provider, both good and bad, with the furniture retailer where they made their purchase. Hence, furniture and home-care related retailers desire protection plan providers who give quality attention to customers that will create positive word-of-mouth advertising and repeat business for the furniture retailer. Unfortunately, the amount of criteria available to distinguish one plan provider from another is limited. Protection plan providers struggle to set themselves apart to furniture retailers looking to purchase protection plans, e.g. by providing various statistics and customer feedback.

### SUMMARY OF THE INVENTION

The aforementioned problems are overcome by a system for providing a unique blend of home care related services to supplement furniture protection plans. In one embodiment, the combination of services includes e-mail reminders on home care, professional technician referrals, promotional home-care service giveaways, and home-care related tips and products. Customers access these services on an Internet website using a Uniform Resource Locator (“URL”) and a unique offer code available on their furniture protection plan. Optionally, an identical code may be used to request service on the customer's protection plan.

In one embodiment, each offer code is recorded in a protection plan database along with the furniture retailer that purchased or otherwise obtained the associated protection plan. Using the offer code, the website can be dynamically tailored to each furniture retailer by including their logo or other retailer specific content. Consumers utilizing the supplemental services are requested to provide personal information, e.g. name, address, and furniture purchased. This information allows the customer to be instantly identified when requesting service on their protection plan. Contrast this with the conventional system where the customer contact information would likely be unknown to the plan provider at the time of the service request.

The user information may be used in other ways as well. In one embodiment, specifically tailored home care advice and tips on topics covering stain removal, home furnishings, home safety, home organization, or pet care in the home is provided based on the user's information. Many of the tips focus on important home maintenance tasks. The tasks are linked with a reminder service that allows users to schedule delayed e-mails to be sent as a reminder to perform specific tasks. Optionally, the user may customize the reminder service for non-home maintenance related tasks (e.g. anniversaries, birthdays, etc.).

Customized technician referrals ease the difficulties of finding a suitable technician to perform whatever maintenance is needed. In one embodiment, the technician referral system uses information entered by the consumer to search a database, apply various criteria, and recommend a technician to service their specific need.

Periodically, these maintenance related tasks are given away as a promotion to protection plan customers, either by retailer sponsors or the plan provider. These free offers give an incentive for protection plan customers to use the supplemental services. Regular use of the supplemental services may encourage customers to regularly perform home-care related maintenance tasks which ultimately may reduce the number of problems requiring service on their protection plans.

The combination of online supplemental services provide various benefits to the protection plan provider, furniture retailers, and the customers. Pre-service contact between the protection plan provider and the customers gives a chance for various home-care related content to be disseminated which may help prevent future services from being needed. The protection plan provider may make online sales of products because of the online traffic related to the various supplemental services.

The present invention also provides various benefits to the furniture retailer. The online supplemental services provide the consumer with a better experience and may increase the goodwill to the furniture retailer. Further, the online supplemental services present multiple opportunities for additional marketing. Because the protection plan provider associates the offer code with the furniture retailer in the database, essentially any aspect of the online services may be tailored to include furniture retailer content. In one embodiment, the furniture retailers are given the opportunity to include direct marketing messages in the e-mail reminders sent out by the task scheduling service. Yet another benefit to the furniture retailer is that essentially any information collected about the customer directly or indirectly by the online furniture protection provider's services may be relayed back to the furniture retailer.

The present invention also provides various benefits to the protection plan customers. The customers receive the benefits of increased efficiency and lower cost. The task scheduler provides reminders to help prevent damage to their investment in the long run. The technician referral service locates a qualified technician to perform maintenance, repair, or cleaning at the lowest cost within the network. The promotional giveaways provide an opportunity for free or reduced cost labor that would ordinarily not be covered under the protection plan. Further, the customer is provided with a variety of content, links, tips, suggestions and other information to assist them with a variety of home maintenance and care issues, including those not directly related to home furnishings.

These and other objects, advantages, and features of the invention will be readily understood and appreciated by reference to the detailed description of the current embodiment and the drawings.

### BRIEF DESCRIPTION OF THE DRAWINGS

FIG. 1 illustrates a system diagram of the online protection plan supplemental service system.

FIG. 2 is a block diagram of one combination of supplemental services provided by the online protection plan supplemental service system.

FIG. 3 is a flowchart of a system for providing a customized home care task scheduler to protection plan customers.

FIG. 4 is a flow chart of a system for providing promotional giveaways to protection plan customers.

FIG. 5 is a flow chart of a system for providing technician service referrals to protection plan customers.

FIG. 6 is a block diagram of a portion of the database structure for use with customer registration in the online protection plan supplemental service system.

FIG. 7 is a block diagram of a portion of the database structure for use with the customized home care task scheduler.

FIG. 8 is a block diagram of a portion of the database structure for use with technician service referrals.

FIG. 9 is an exemplary screenshot of a website for providing online supplemental protection plan services.

### DESCRIPTION OF THE CURRENT EMBODIMENT

### I. General Description

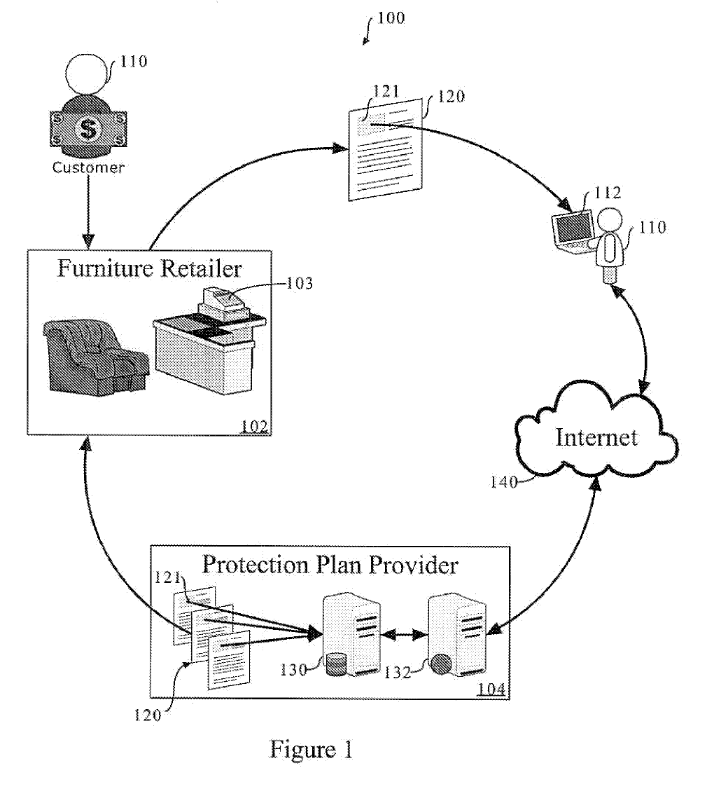

A system or method for providing a combination of protection plan supplemental online services in accordance with an embodiment of the present invention is shown in FIG. 1, and generally designated 100. The system 100 generally includes a protection plan provider 104, a furniture retailer 102, a customer 110, protection plans 120, a personal computer 112, and the Internet 140. The protection plan provider 104 generally includes a database 130 and a web server 132. Each of the protection plans 120 include a unique code 121 which links the furniture retailer 102 to each of the purchased protection plans 120 in the database 130. The system 100 facilitates various interactions between protection plan customers 110, protection plan providers 104, and furniture retailers 102 to provide a combination of online services which supplement or add value to conventional furniture protection plans. Although the supplemental services are described with reference to furniture protection plans, the invention is not so limited, online supplemental services may be for essentially any home-care related protection plan, such as carpeting and other floor coverings.

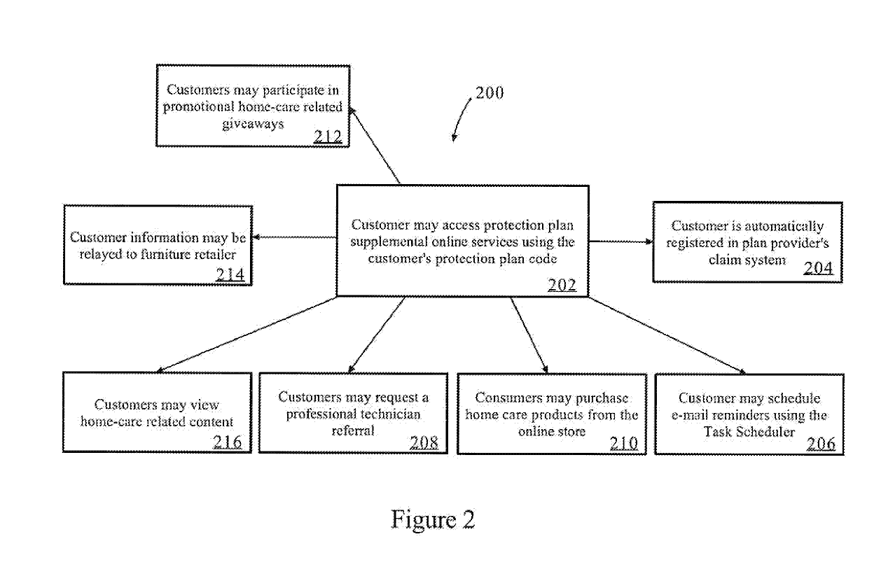

A block diagram illustrating a combination of services provided in accordance with one embodiment of the present invention is shown in FIG. 2, and generally designated 200. The supplemental online services 200 provided in conjunction with a customer's protection plan 120 include 1) access to a customized website using the protection plan code 202; 2) automatic registration in the protection plan provider's service request system 204; 3) custom e-mail reminders using the task scheduler 206; 4) home-care related professional technician referrals 208; 5) an online store offering home-care related products 210; 6) entry into home-care related promotional giveaways 212; 7) relay of customer information to the furniture retailer where the protection plan was purchased 214; and 8) access to home-care related content 216. Alternative embodiments may include additional, different, or fewer combinations of supplemental online services. Although the current embodiment is described in connection with a personal computer 112, the present invention is not limited to use of conventional computers. The present invention can be incorporated into essentially any device that provides access to the Internet 140, including cell phones, personal digital assistants, or the like.

### II. Detailed Description of the System Structure

Some portions of the detailed descriptions which follow (e.g., systems 100, 300, 400, 500) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the window of electrical or magnetic signals capable of being stored, transferred, combined, compared, and otherwise manipulated in a computer system. It has proven convenient at times, principally for reasons of common usage, to refer to these signals as values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “determining” or “displaying” or “recognizing” or “generating” or “selecting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

For illustrative purposes the present invention is embodied in the system configuration, method of operation and product or computer-readable medium, such as floppy disks, conventional hard disks, CD-ROMS, DVDS, Flash ROMS, nonvolatile ROM, RAM and any other equivalent computer memory device, generally shown herein. It will be appreciated that the system, method of operation and product may vary as to the details of its configuration and operation without departing from the basic concepts disclosed herein.

In the described embodiment, the protection plan provider 104 is a generally conventional protection plan provider that generates protection products and services that furniture retailers 102 resell to their customers 110. One type of protection product offered is the furniture protection plan 120. The type and scope of the protection plans 120 available may vary based on the furniture retailer's 102 individual needs or on other suitable factors. Examples include individual fabric, leather, or mattress plans or combination plans for multiple item purchases of fabric, leather, vinyl upholstery, area rugs, mattresses, case goods, or other hard surface furniture. In the current embodiment, the protection plans are physically generated and processed by the protection plan provider 104 and then shipped to the furniture retailer 102. In alternative embodiments, the protection plans 120 are virtually generated on a computer and processed by the protection plan provider 104 before being transmitted to the furniture retailer 102 for printout at their location. Although the current embodiment is described with respect to furniture protection plans 120, other home-care related protection plans may be substituted as applicable.

In the described embodiment, the protection plan documents 120 lay out the details of the protection plan and provide a telephone number, a service URL, and a supplemental service URL. The service URL directs the customer to the protection plan provider's website where information about their protection plan may be obtained and where a service request against the protection plan may be filed. The supplemental service URL directs the customer to the protection plan provider's supplemental service website. In alternative embodiments, the protection plans 120 may be virtual documents that are transferred electronically between the furniture retailer 102, protection plan provider 104, and the customer 110. Although in the described embodiment the protection plans are physically transferred from the protection plan provider 104 to the furniture retailer 102, in alternative embodiments the furniture retailer may print the plans themselves according to the protection plan provider's instructions. The protection plans 120 generally include a unique code 121 for accessing the online supplemental services. In some embodiments, the unique code 121 doubles as an access code to make a service request on the protection plan with the protection plan provider, either telephonically or online. Although not the case in the described embodiment, the services offered by the protection plan provider may be included at the same URL as the supplemental services.

In the described embodiment, the protection plan provider includes a database 130 and a web server 132. Both are generally conventional. Although the database 130 and the web server 132 of the current embodiment are controlled and kept on site by the protection plan provider 104, that need not be the case. In other embodiments, one or both of the database 130 and web server 132 may be controlled by a third party, kept off site, or both. The web server 132 includes the web pages which provide the supplemental online services to be discussed in more detail below and the database 130 includes data for use with those web pages. The specific configuration of the database 130 and web server 132 is merely exemplary; essentially any configuration of computer elements may be used to provide the supplemental protection plan online services.

In the current embodiment, the furniture retailer 102 is a generally conventional furniture retailer that offers furniture for sale to customers 110 at a storefront. Generally, at the point of sale 103 the furniture retailer offers a protection plan 122 to the customer 110. However, the protection plan 122 may be sold to the customer at a different place or time. For example, protection plans may be purchased online or through the mail either at the time of sale or some other time.

In the current embodiment, the personal computer 112 is a generally conventional personal computer that allows the customer 110 to access the Internet 140. The computer 112 may be essentially any computer 112, including, but not limited to, the customer's home personal computer or computers provided at the furniture retailer's storefront. The computer 112 generally allows the customer 110 to access a URL provided on the customer's protection plan 120 using a web browser. Once the customer's web browser is pointed at the appropriate website, the customer may register or log on to the protection plan provider's supplemental service website using the unique code 121 on the customer's protection plan 120. In some embodiments, the code 121 is not the only way to access the protection plan supplemental services. Instead, the code 121 may be entered during the registration process to bypass or reduce a subscription fee associated with membership of the website 900.

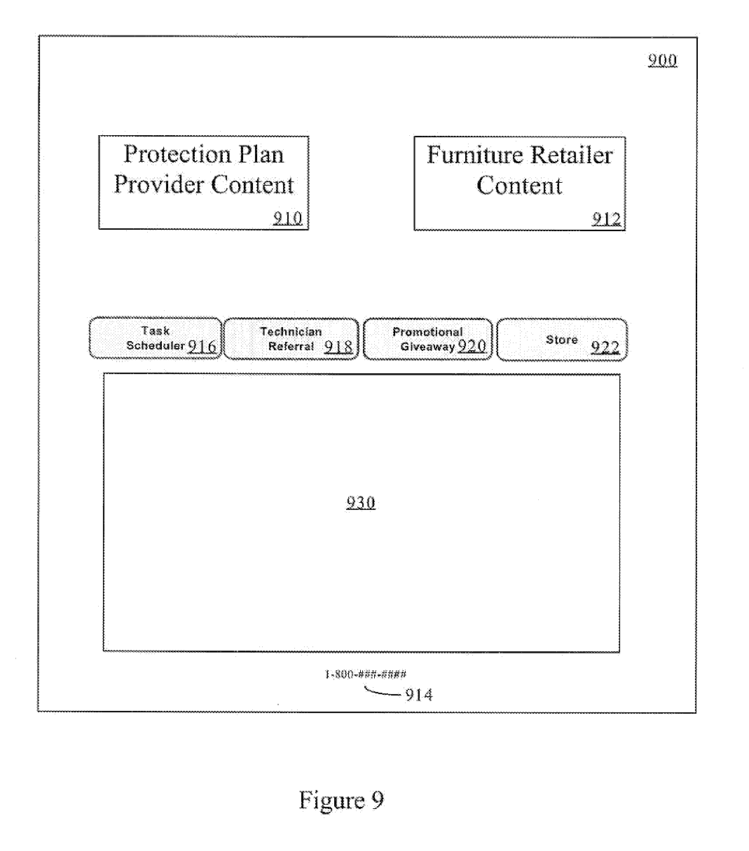

Referring to FIG. 9, one embodiment of the protection plan provider's online supplemental service website 900 is shown. The website 900 generally includes protection plan provider content 910, furniture retailer content 912, a toll free number to contact the protection plan provider 914, a task scheduler service 916, a technician referral service 918, a promotional giveaway service 920, a home-care store 922, and general home-care content 930. In order to access the website 900 the customer enters their code 921 into a registration page (not shown) and follows a registration process which solicits personal information about the customer. Once registered, the customer may access the website 900 which is essentially a gateway to the various supplemental services provided by the protection plan provider. The website 900 is not limited to the configuration depicted in FIG. 9, essentially any known web design techniques may be applied to create the protection plan provider's website which embodies the supplemental protection plan services. In one embodiment, the Cold Fusion scripting language is used to implement the website 900 along with the various services provided. The scripting language is also capable of accessing the database 130. Although only one webpage is depicted in connection with the current embodiment, the protection plan provider's online supplemental services may be spread across multiple web pages.

The protection plan provider content 910 and the furniture retailer content 912 may vary from application to application. In the described embodiment, the content includes a logo for each with a link to the corresponding website. In alternative embodiments, the content may be nonexistent or more extensive. For example, in one embodiment no protection plan provider content 910 is provided and the website 900 is fully integrated with furniture retailer content. In an integrated retailer content embodiment, the website 900 may be designed such that the protection plan provider is invisible to the customer using the supplemental online protection plan services.

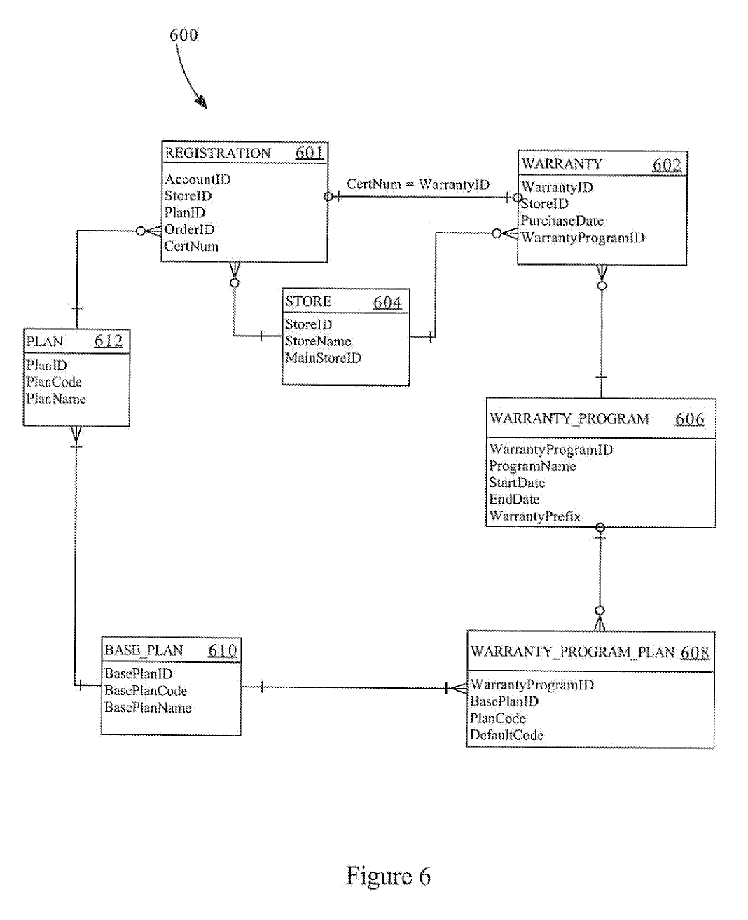

In the current embodiment, the website 900 includes links to the various supplemental services. In the described embodiment these services are implemented through a series of scripted web pages that query the database 130. The structure of the database 130 is described below with reference to FIGS. 6-8. It is understood that the described structure of the database 130 is merely exemplary, and the database 130 could be implemented differently depending on the particular application.

Referring to FIG. 6, an exemplary relationship diagram 600 for use in tracking the partnership between the protection plans 120, the furniture retailer 102, and the customer 110 is shown. The diagram includes a registration table 601, a warranty table 602, a store table 604, a warranty_program table 606, a warranty_program_plan table 608, a base_plan table 610, and a plan table 612. Additional, different, or fewer tables may be used to implement the plan provider-furniture retailer partnership.

In the described embodiment, the registration table 601 generally includes fields for AccountID, StoreID, PlanID, OrderID, and CertNum. Additional, different, or fewer fields may be used to implement the registration table 601. The AccountID is a unique identifier for distinguishing between registered customers. The StoreID is an identifier used to distinguish between furniture retailers 102. The PlanID is an identifier used to distinguish between types of protection plans. OrderID is an identifier used to distinguish between the batches of orders sent to furniture retailers. CertNum is a unique identifier associated with a particular protection plan, typically the code 121 on the protection plan 120. Generally, the registration table 601 stores the link between the customer 110, the customer's protection plan 120, and the furniture retailer 102.

In the described embodiment, the Plan table 612 includes fields for PlanID, PlanCode, and PlanName. The PlanID is a unique identifier to distinguish between types of protection plans 120. The PlanCode is a sub-identifier to further describe the protection plan of a particular PlanID. The PlanName is a textual description of a protection plan with a particular PlanID. Generally, the Plan table 612 stores information related to all of the different kinds of protection plans that the protection plan provider offers.

In the described embodiment, the Base_Plan table 610 groups various similar Plans under broader Plan categories, both for reporting purposes and to relate to any protection plan provider warranty software. The Base_Plan table 610 includes fields for BasePlanID, BasePlanCode, and BasePlanName. The BasePlanID is a unique identifier to distinguish between general categories of protection plans. The BasePlanCode is a sub-identifier to further describe the protection plans of a particular PlanID category. The BasePlanName is a textual description of a category of protection plans with a particular BasePlanID. The Base_Plan table 610 groups various similar protection plans under broader plan categories, both for reporting purposes and to relate to any protection plan provider software.

In the described embodiment, the Warranty_Program table 606 includes fields for WarrantyProgramID, ProgramName, StartDate, EndDate, and WarrantyPrefix. The WarrantyID (in Warranty Table) is the same as the CertNum and the codes 121 on the customers' protection plans 120, it uniquely identifies the protection plans 120. The WarrantyProgramID is a numeric, unique record identifier in the Warranty_Program Table. The ProgramName is a textual description of the plan without the warranty prefix. The StartDate and EndDate include the specific dates the protection plan begins and ends. In some embodiments, the StartDate and EndDate may be calculated from the PurchaseDate and the type of warranty. The WarrantyPrefix is a textual prefix which allows one BasePlan-Warranty Program relationship to support multiple plan prefixes, e.g. WUA5A and UA5A belong to the same BasePlan. The plan prefixes may be used to uniquely identify the type and coverage specifications of the plan. For example, in this embodiment, the prefix elements include the following keys: “UA”=Ultra coverage, “5”=5 years of coverage, “A” is revision A. The “W” in the first sample prefix indicates the plan is a “warranty” version of the plan, instead of a service contract.

In the described embodiment, the Warranty_Program_Plan table 608 includes fields for WarrantyProgramID, BasePlanID, PlanCode, and DefaultCode. The WarrantyProgramID is the identifier for the Warranty_Program in table 606. The BasePlanID identifies the category of protection plan. The PlanCode is a sub-identifier that further describes the protection plan. The DefaultCode is a fallback PlanCode that is used if no specific PlanCode is provided. The Warranty_Program_Plan table 608 stores the relationships between base plan groupings and corresponding warranty programs.

In the described embodiment, the Warranty table 602 includes fields for WarrantyID, StoreID, PurchaseDate, and WarrantyProgramID. The WarrantyProgramID. is the identifier for the Warranty_Program in table 606. The StoreID identifies the furniture retailer 102 that sold the protection plan with the associated WarrantyID. Generally, the Warranty table 602 stores which furniture retailers have purchased which warranties.

In the described embodiment, the Store table 604 includes fields for StoreID, StoreName, and MainStoreID. The StoreID uniquely identifies the furniture retailer 102. The StoreName is a textual description of the furniture retailer 102. The MainStoreID is an identifier to distinguish whether a particular store is a branch location. Generally, the store table 604 stores a list of furniture retailers the protection plan provider deals with.

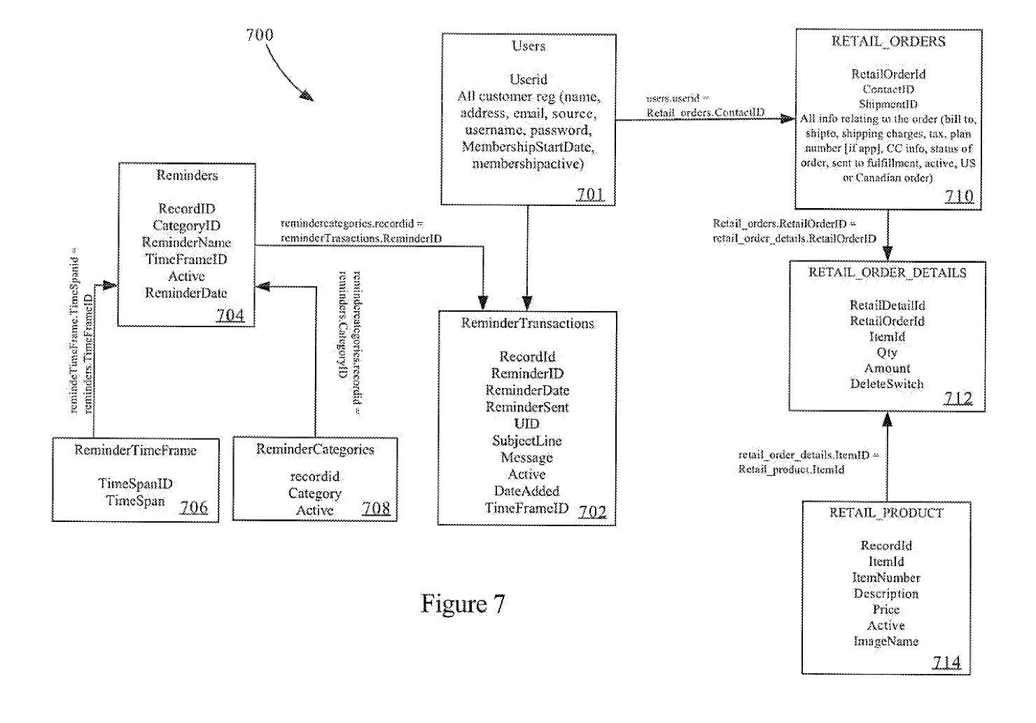

Referring to FIG. 7, an exemplary relationship diagram 700 for use with the task scheduler and the online home-care store is shown. The diagram includes a Users table 701, a ReminderTransactions table 702, a Reminders Table 704, a ReminderTimeFrame table 706, a ReminderCategories table 708, a Retail_Orders table 710, a Retail_Order_Details table 712, and a Retail_Product table 714. Additional, different, or fewer tables may be used to implement the task scheduler and online home-care store.

In the described embodiment, the Users table 701 includes fields for Userid, name, address, email, source, username, password, MembershipstartDate, membershipactive. The Userid is a unique identifier that distinguishes between users. Name is the users real name. Address is the user's address information. Email is the user's email address. Source identifies how the user learned of the TLC service, e.g. plan code, retailer, etc. Username is the username chosen by the user, which may or may not correspond with the user's actual name. Password is the user's password for entry to the website. MembershipStartDate is the date that the user registered. Membershipactive is a binary field that indicates whether or not the user's membership is active. The User table generally stores all of the information entered by the customer when registering for the first time.

In the described embodiment, the ReminderTimeFrame table 706 includes fields TimeSpanID and TimeSpan. The TimeSpanID uniquely identifies a specific TimeSpan. TimeSpan is an identifier that indicates how often reminders should be sent. Weekly, bi-weekly, monthly, quarterly, and yearly are exemplary TimeSpan values.

In the described embodiment, the ReminderCategories table 708 includes fields for RecordID, CategoryID, and Active. The recordid is a unique identifier that distinguishes between categories of reminders. The Category is a textual description of the type of reminder. Active is a binary identifier that indicates whether or not a particular reminder category is active.

In the described embodiment, the Reminders table 704 includes fields for RecordID, CategoryID, ReminderName, TimeFrameID, Active, and ReminderDate. The RecordID is a unique identifier that distinguishes between individual reminders. The CategoryID is an identifier that identifies the reminder category for a specific RecordID. The CategoryID is linked with the recordid in the ReminderCategories table 708. The TimeFrameID identifies which time span the reminder uses. The TimeFrameID is linked with the TimeSpanID in the ReminderTimeFrame table 706. Active is a binary identifier that indicates whether a specific reminder is active or not. This allows inactive reminders to lie dormant so if a user chooses to activate a particular reminder all of the information does not need to be entered. The ReminderDate is an identifier that identifies the date on which a particular task is to be performed. Generally, the Reminder table 704 stores the information of all of the pre-defined reminders that are visible for a user to select from.

In the described embodiment, the ReminderTransactions table 702 includes fields for RecordID, ReminderID, ReminderDate, ReminderSent, UID, SubjectLine, message, active, DateAdded, TimeFrameID. The RecordID is a unique identifier that distinguishes between different e-mails sent for a particular reminder. ReminderID is an identifier that distinguishes between each unique reminder transaction. The ReminderID is linked to the RecordID in the Reminders table 704. The ReminderDate is the date when a specific e-mail reminder is to be sent. ReminderSent is a binary flag that indicates whether or not the reminder has been sent yet. The UID is an identifier that distinguishes between users. The UID is linked with the UserID of the Users table 701. The SubjectLine is a textual description of the subject line of the reminder e-mail. The Message is a textual description of the body of the reminder e-mail. The SubjectLine and Message may be tailored to a specific user, reminder category, specific reminder, or any other suitable field. Active is a binary flag that indicates whether a specific reminder e-mail will be sent. DateAdded is the date which the reminder e-mail was setup. TimeFrameID identifies when the reminder e-mail should be sent. Generally, the ReminderTransactions table 702 stores the individual reminder e-mails to be sent and various information about those reminders.

In the described embodiment, the RETAIL_ORDERS table 710 includes fields for RetailOrderId, ContactID, ShipmentID, and other various fields related to orders. The RetailOrderID is a unique identifier that distinguishes between retail orders. ContactID is an identifier that distinguishes between users. The ContactID is linked with the Userid in the Users table 701. The ShipmentID indicates which shipment this order is associated with. Additional fields include, BillTo, ShipTo, ShippingCharges, Tax, PlanNumber, CreditCardInfo, StatusOfOrder, SentToFulfillment, Active, USorCanada. These fields provide information on the where the products are to be shipped and billed, how much the shipment is going to cost, any tax associated with the shipment, any protection plan number that the products are covered under, any credit card information used to pay for the order, the current status of the order, whether the order has been fulfilled, whether the order is actively being processed, and whether the order is being sent to the U.S. or Canada. Generally, the RETAIL_ORDERS table 710 stores information related to payment and shipment of the order.

In the described embodiment, the RETAIL_ORDER_DETAILS table 712 includes fields for RetailDetailId, RetailOrderId, ItemId, Qty, Amount, Deleteswitch. The RetailDetailID is a unique identifier that distinguishes between order details. The RetailOrderID is an identifier that distinguishes between orders. The RetailOrderID is linked to the RETAIL_ORDERS table 710. The ItemID is an identifier that distinguishes between the purchased products. Qty is the quantity of purchased products. Amount is the total cost of a particular quantity of items purchased. DeleteSwitch is a binary flag that indicates whether or not a specific order is deleted. Generally, the RETAIL_ORDERS_DETAILS table 712 stores information related to the contents of the order.

In the described embodiment, the RETAIL_PRODUCT table 714 includes fields for RecordID, ItemId, ItemNumber, Description, Price, Active, ImageName. The RecordID is a unique identifier that distinguishes between individual products. In this embodiment, RECORDID is a unique counter field on the data table that is a record counter. ItemID is a unique identifier that distinguishes each individual item. The ItemID is linked with the ItemID of the RETAIL_ORDER_DETAILS table 712. The ItemNumber is an inventory stock number that is linked to an inventory SKU number found in an inventory system, not shown here. In this embodiment, ItemNumber is like a SKU number in the sense that it is used to track unique inventory items. Description includes text describing the product. Price is the value of the product. Active is a binary flag that indicates whether or not a specific product is available. ImageName is a file identifier that indicates the image of the product. Generally, the RETAIL_PRODUCT table 714 stores information related to the individual products.

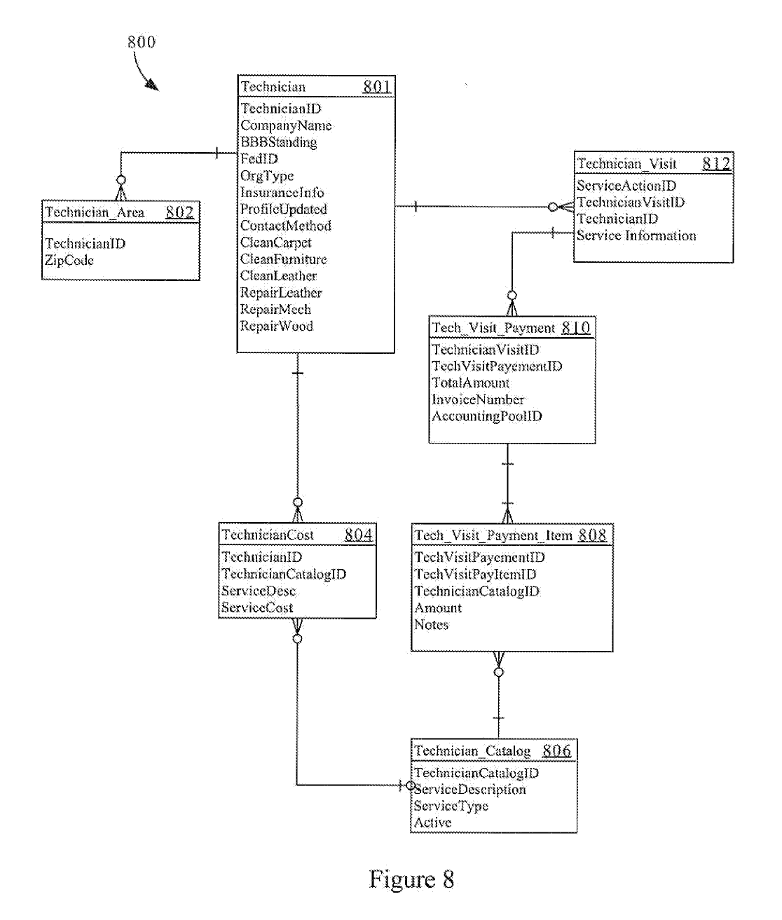

Referring to FIG. 8, an exemplary relationship diagram 800 for use with the technician referral service is shown. The diagram includes a Technician table 801, a Technician_Area table 802, a TechnicianCost table 804, a Technician_Catalog table 806, a Tech_Visit_Payment_Item table 808, a Tech_Visit_Payment table 810, and a Technician Visit table 812. Additional, different, or fewer tables may be used to implement the technician referral service.

In the described embodiment, the Technician table 801 includes fields for TechnicianID, CompanyName, BBBStanding, FedID, OrgType, InsuranceInfo, ProfileUpdated, ContactMethod, CleanCarpet, CleanFurniture, CleanLeather, RepairLeather, RepairMech, RepairWood. The TechnicianID is a unique identifier that distinguishes between technicians. CompanyName is the company that employs the technician. BBBStanding indicates the technicians standing with the better business bureau. FedID is an identifier of the technicians federal employment number. OrgType is the type of organization to which the technician belongs. InsuranceInfo identifies who the technician has insurance through. ProfileUpdated indicates the last time this technician's profile was updated. ContactMethod indicates the how to contact the technician. CleanCarpet, CleanFurniture, CleanLeather, RepairLeather, RepairMech, RepairWood are all binary flags which indicate the skills of the technician. Generally, the Technician table 801 stores information about each technician within the protection plan provider's preferred network of technicians.

In the described embodiment, the Technician Area table 802 includes fields for Technician and ZipCode. The TechnicianID is an identifier that distinguishes between technicians. ZipCode includes the specific postal zip codes the technician will travel to for a service call. Generally, the Technician Area table 802 stores information about where each technician will perform services.

In the described embodiment, the TechnicianCost table 804 includes fields for TechnicianID, TechnicianCatalogID, ServiceDesc, ServiceCost. TechnicianID is an identifier that distinguishes between technicians. TechnicianCatalogID is a unique identifier that distinguishes between a specific technicians services. ServiceDesc is a textual description of the specific services provided by a specific TechnicianCatalogID. ServiceCost is the amount of the services for a specific TechnicianCatalogID. Generally, the TechnicianCost table 804 stores service technicians standard prices for the various services they are capable of performing. Generally, the TechnicianCost table 804 stores information about the cost of particular services as described by the technician.

In the described embodiment, the Technician_Catalog table 806 includes fields for TechncianCatalogID, ServiceDescription, ServiceType, Active. The TechnicianCatalogID is an identifier that distinguishes between services provided by technicians generally. The TechnicianCatalogID is linked with the TechnicianCatalogID in the TechnicianCost table 804. The ServiceDescription provides a unique standardized textual description for a group of TechnicianCatalogIDs. The ServiceType is an identifier that categorizes the ServiceDescriptions. Active is a binary flag that determines whether a particular ServiceDescription is active. Generally, the Technician_Catalog table 806 is a setup table storing standard services performed by service technicians in a network.

In the described embodiment, the Tech_Visit table 812 includes fields for ServiceActionID, TechnicianVisitID, TechnicianID, and ServiceInformation. The ServiceActionID is a unique identifier that distinguishes between services performed by a technician for a customer. TechnicianVisitID is an identifier that distinguishes between visits to perform a particular service for a customer. TechnicianID is an identifier that distinguishes between technicians. The TechnicianID is linked with the Technician table 801. The ServiceInformation includes miscellaneous information about the service call. The Tech_Visit table 812 generally provides service call information, e.g. date of work, technician assigned, and comments about the service performed.

In the described embodiment, the Tech_Visit_Payment table 810 includes fields for TechnicianVisitID, TechVisitpaymentID, TotalAmount, InvoiceNumber, AccountingPoolID. The TechnicianVisitID is an identifier that distinguishes between visits to perform a particular service for a customer. The TechVisitPaymentID is an identifier that indicates a payment by the customer for a corresponding TechnicianVisitID. The TotalAmount indicates the total amount of money owed to the technician for a particular service call. The InvoiceNumber is an identifier that distinguishes between invoices. The AccountingPoolID is an identifier that links to each payment record found in our Accounting tables, not shown here. The Tech_Visit_Payment table 810 provides information about payments made to technicians for a particular service call.

In the described embodiment, the Tech_Visit_Payment_Item table 808 includes fields for TechVisitPaymentID, TechVisitPayItemID, TechnicianCatalogID, Amount, Notes. The TechVisitPaymentID is an identifier that distinguishes between payments for a particular service call. The TechVisitPaymentID is linked to the Tech_Visit_Payment table 810. The techvisitPayItemID is a unique identifier that distinguishes between payments of particular line items on the invoice. The TechnicianCatalogID is an identifier that distinguishes between the services provided by technicians generally. The amount indicates the cost for the particular line item of the invoice. Notes provides a place for any comments concerning a particular line item of the invoice.

The database structure described above with respect to FIGS. 6-8 is merely exemplary. The database implementation for the protection plan supplemental services may vary from application to application. In alternative embodiments, the database 130 may include additional, different, or fewer tables, fields, or relationships. Further, the described database structure may be shared, copied, or made accessible by the protection plan provider as desired. For example, the protection plan provider may access the database 130 in their protection plan software to eliminate or reduce redundancy.

### III. Detailed Description of the System Services

A block diagram illustrating a combination of services provided in accordance with one embodiment of the present invention is shown in FIG. 2, and generally designated 200. The online services 200 provided in conjunction with a customer's protection plan 120 include 1) access to a customized website using the protection plan code 202; 2) automatic registration in the protection plan provider's service request system 204; 3) custom e-mail reminders using the task scheduler 206; 4) home-care related professional technician referrals 208; 5) an online store offering home-care related products 210; 6) access to home-care related content; 7) entry into home-care related promotional giveaways 212; and 8) relay of customer information to the furniture retailer where the plan was purchased. Alternative embodiments may include additional, different, or fewer combinations of services.

In one embodiment, one service offered by the system is access to a customized website using the protection plan code. The website 900 may be customized based on the customer 110, the protection plan 120, the furniture retailer 104 where the plan was purchased, or any combination thereof. In the described embodiment, when the customer registers at the website 900 with their protection plan code 121 it is matched in the database 130 with the furniture retailer 102 that sold that specific protection plan. The protection plan code 121 essentially links the furniture retailer 102, protection plan provider 104, and customer 110, as shown in FIG. 1 and FIG. 6. Using the database 130, the website 900 may be dynamically tailored based on essentially any field in the database 130. In the described embodiment, the website 900 features the logo of the specific furniture retailer 102 that sold the customer 110 the protection plan 120. In alternative embodiments, additional retailer specific or other content may be included. Accordingly, access to a customized website using the protection plan code is provided by the system.

Another service provided in one embodiment of the system is automatic registration in the protection plan provider's service request system. Consumers utilizing the supplemental services are requested to register and provide personal information, e.g. name, address, and furniture purchased. Once registered, the web server 132 automatically sends the customer's information to the protection plan provider's service request system (not shown). This information may be used in the future if a customer 110 submits a service request on their protection plan 120.

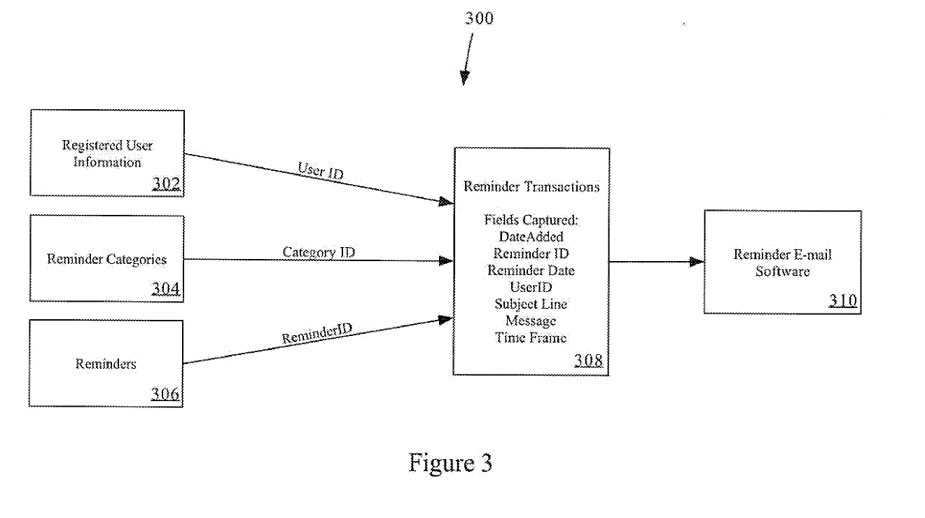

Once registered and logged into the website 900, the customer 110 may access the online home care task scheduler. Referring to FIG. 3, a flowchart 300 describing one embodiment of a task scheduler is illustrated. In the described embodiment, the customer 110 may select from a series of pre-programmed reminder categories 304 and specific reminders 306. The customer may also select from various options for each selected reminder. For example, the type of reminder, the subject message for the reminder, the dates the reminder should be sent (one time, monthly, quarterly, etc.), and any additional text to include in the reminder message. These options are merely exemplary; in other embodiments additional options may be available. Customers may save a virtually unlimited number of reminders within their account. Individual reminders may be deleted altogether or merely deactivated for later use. Once a day, a script on the web server 132 initiates a search of the database 130 for any reminder e-mails due to be sent. If reminder messages are due, the web server 132 and database 130 generate each reminder e-mail and send them out through an e-mail server (not shown) to the user's e-mail address. Once each e-mail is confirmed to be sent, the database notes the email was sent. In addition to pre-programmed home-care related reminders, in some embodiments additional custom reminders may be set as desired by the customer 110. Although a specific graphical user interface is not described in connection with the task scheduler, a person of skill in the art would understand how to create a suitable user interface.

Once registered and logged into the website 900, the customer may access the technician referral service. To initiate the technician referral service, the customer 110 is prompted to fill out a technician referral request form on the website 900. This form may include: contact information, a preferred method of contact, and a service request. The service request generally details whether the requested service is a maintenance cleaning, a stain, or a repair. There is also room for a detailed description of the request. In one embodiment, the form is transferred and processed by the protection plan provider's system.

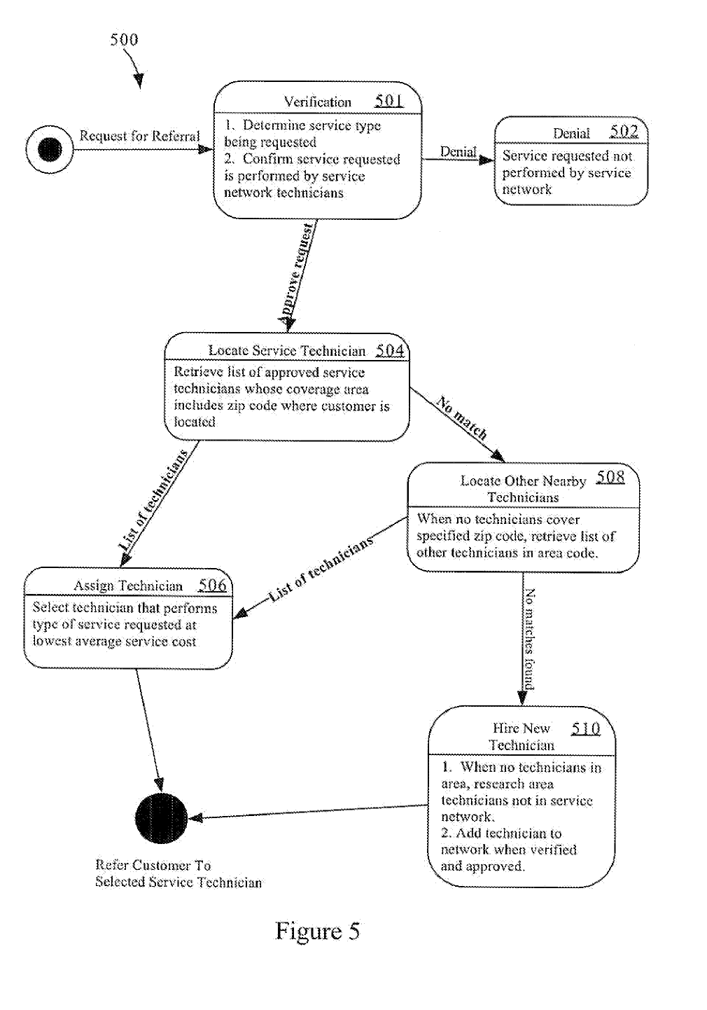

Referring to FIG. 5, a flowchart 500 describing one embodiment of a technician referral service is illustrated. The technician referral service includes the steps of: verifying that the type of service requested is offered 501; denying the referral if the verification fails 502; locating network service technicians in the same zip code as the customer 504; locating network service technicians in the same area code as the customer if none were found in the zip code 508; assigning a technician from the network based on lowest average cost if one can be found in the customer's zip code or area code 506; and hiring a new technician if no technicians from the network can be found in the customer's zip code or area code 510. Optionally, additional steps may be taken during the technician referral service. For example, the selected technicians service history may be reviewed. In one embodiment, any technicians who have received negative feedback reports are excluded from being referred. In alternative embodiments, this criteria is substantially relaxed. The technicians' history with the online Better Business Bureau database may also be searched. In one embodiment, any technician with an unresolved complaint is excluded from being referred. Although in the described embodiment the technician referrals are processed by a protection plan provider staff member, in alternative embodiments the technician referrals may be fully or partially automated by the protection plan provider's web server or other software. In partially automated embodiments, a protection plan provider staff member supervises and approves the automated work.

In the described embodiment, once a qualified technician referral is located and properly screened, a protection plan provider staff person initiates an e-mail response to the customer 110 with the technician referral information. The referred technician is copied on the referral response to the customer, and will be expected to follow up with the customer within two business days.

Once registered and logged into the website 900, the customer may access the online store offering home-care related products or various home-care related content. In some embodiments, the specific products or home-care related content may be tailored based on information provided by the customer that is stored in the database 130 or on the type of protection plan 120 the customer purchased.

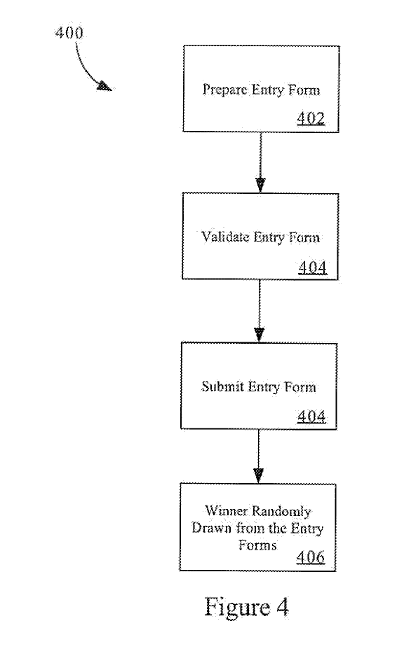

Once registered and logged into the website 900, the customer may access the promotional giveaways. Referring to FIG. 4, the promotional giveaway service includes the steps of: 1) preparing an entry form 400; 2) validating the entry form 402; 3) submitting the entry form 404; and 4) randomly drawing the winner from the submitted entry forms 406. The timing and scope of the promotional giveaways may vary based on the protection plan, furniture retailer, or other various factors. In some embodiments, access to specific promotional giveaways is provided by links in the online store or in the home-care related content on the website 900. In other embodiments, the promotional giveaways are fully automated by registering and logging in to the website 900. Examples of promotional giveaways may include: free carpet cleaning for the customer's home, free home-care related products, discounts on the online store, free shipping for the online store, and gift certificates to specific furniture retailers.

Once registered and logged into the website 900, any information provided by the customer or actions taken by the customer on the website 900 may be recorded and relayed back to the furniture retailer 102 where the customer 110 purchased the protection plan 120.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A method of providing online protection plan supplemental services to a retail customer comprising:
selling a plurality of protection plans each with a corresponding unique code to a furniture retailer;
associating the plurality of protection plans with the furniture retailer in a database using the unique codes, before transfer of the protection plan to the furniture retailer;
transferring the protection plan to the furniture retailer;
reselling the protection plan to the retail customer;
associating the retail customer with the protection plan and the furniture retailer in the database using the unique code of the retail customer protection plan; and
providing a combination of online protection plan supplemental services to the retail customer over the Internet customized based on the furniture retailer where the protection plan was purchased.

2. The method of claim 1 wherein said codes allow the retail customer to file a service request on the protection plan.

3. The method of claim 1 wherein the combination of online protection plan supplemental services includes a home care task scheduler service, technician referral service, and a promotional giveaway service.

4. The method of claim 1 wherein the combination of online protection plan supplemental services includes a home care task scheduler service and a promotional giveaway service.

5. The method of claim 1 wherein the combination of online protection plan supplemental services includes a home care task scheduler service and a technician referral service.

6. The method of claim 1 wherein the combination of online protection plan supplemental services includes a technician referral service and a promotional giveaway service.

7. An online protection plan supplemental service system comprising:
a plurality of protection plans, wherein each protection plan includes a unique code;
a protection plan provider database;
a furniture retailer, wherein said furniture retailer purchases said plurality of protection plans for resale, wherein each unique code of said plurality of protection plans is associated with said furniture retailer in said database;
a customer, wherein said customer purchases said protection plan from said furniture retailer; and
a combination of online protection plan supplemental services, wherein said customer accesses said combination of online protection plan supplemental services using said unique code of said protection plan.

8. The online protection plan supplemental service system of claim 7 wherein said codes allow the customer to file a service request on the customer's protection plan.

9. The online protection plan supplemental service system of claim 7 wherein the combination of online protection plan supplemental services includes a home care task scheduler service, technician referral service, and a promotional giveaway service.

10. The online protection plan supplemental service system of claim 7 wherein the combination of online protection plan supplemental services includes a home care task scheduler service and a promotional giveaway service.

11. The online protection plan supplemental service system of claim 7 wherein the combination of online protection plan supplemental services includes a home care task scheduler service and a technician referral service.

12. The online protection plan supplemental service system of claim 7 wherein the combination of online protection plan supplemental services includes a technician referral service and a promotional giveaway service.

13. A method of supplying furniture protection plan supplemental services to a customer of a furniture retailer comprising the steps of:
generating a plurality of protection plans each with a unique code;
associating a subset of protection plans with the furniture retailer;
recording each association in a database, wherein said association includes each code of the subset of protection plans and the furniture retailer;
providing a dynamic protection plan supplemental service website, wherein the content of the website for a customer depends on the associated furniture retailer as recorded in the association database and wherein access to the website is limited by the unique codes;
transferring the subset of protection plans to the furniture retailer;
selling one of the subset of protection plans to the customer; and
accessing the protection plan supplemental service website using the plan code of the protection plan, wherein the content of the website reflects the associated furniture retailer as recorded in the association database.

14. The method of claim 13 wherein said codes allow the customer to file a service request on the customer's protection plan.

15. The method of claim 13 wherein the combination of online protection plan supplemental services includes a home care task scheduler service, technician referral service, and a promotional giveaway service.

16. The method of claim 13 wherein the combination of online protection plan supplemental services includes a home care task scheduler service and a promotional giveaway service.

17. The method of claim 13 wherein the combination of online protection plan supplemental services includes a home care task scheduler service and a technician referral service.

18. The method of claim 13 wherein the combination of online protection plan supplemental services includes a technician referral service and a promotional giveaway service.

19. An online protection plan supplemental service system for supplementing a protection plan claims system comprising:
a website with dynamic content based on a furniture retailer where the protection plan was purchased;
tailored home-care related content based on information provided by a customer;
an automatic registration module that interfaces with said protection plan system and registers said customer;
a home-care related task scheduler module that sends custom e-mail reminders to said customer;
a home-care related professional technician referral service module that recommends a technician to said customer;
an online store module offering home-care related products;
periodic home-care related promotional giveaways; and
an information relay module which communicates information about the customer to the furniture retailer where the protection plan was purchased.

20. The online protection plan supplemental service system of claim 19 wherein the tailored home-care related content includes advice, tips, and tasks associated with stain removal, home furnishings, home safety, home organization, pets in the home, or any combination thereof, wherein the tasks provide links to pre-programmed e-mail reminders available through said home-care related task scheduler module.
